(19) United States
(12) Patent Application Publication
(10) Pub. No.: US 2013/0063380 A1
(43) Pub. Date: Mar. 14, 2013

(54) USER INTERFACE FOR CONTROLLING RELEASE OF A LOCK STATE IN A TERMINAL

(71) Applicants: Jee Yeun WANG, Seoul (KR); Sun Young YI, Gyeonggi-do (KR); Chang Mo YANG, Gyeonggi-do (KR); Kyu Sung KIM, Seoul (KR); Hee Kyung JEON, Seoul (KR)

(72) Inventors: Jee Yeun WANG, Seoul (KR); Sun Young YI, Gyeonggi-do (KR); Chang Mo YANG, Gyeonggi-do (KR); Kyu Sung KIM, Seoul (KR); Hee Kyung JEON, Seoul (KR)

(73) Assignee: SAMSUNG ELECTRONICS CO., LTD., Gyeonggi-do (KR)

(21) Appl. No.: 13/606,537

(22) Filed: Sep. 7, 2012

(30) Foreign Application Priority Data
Sep. 8, 2011 (KR) 10-2011-0091220

(51) Int. Cl. G06F 3/041

(52) U.S. Cl. 345/173

(57) ABSTRACT

Disclosed are a method and an apparatus for providing a user interface. The apparatus for providing a user interface, includes a controller operating such that a lock image with respect to at least a partial user interface and an object for changing a lock state to a release state are displayed on a screen, and a touch sensor sensing a first contact of a touch gesture on the object, wherein the controller determines a distance between the object and a second contact of the touch gesture with respect to the first contact on the object, and changes the lock state to the release state and the removes the lock image from the screen when the distance between the object and the second contact of the touch gesture is greater than a preset threshold.

### CLAIM OF PRIORITY

This application claims, pursuant to 35 USC 119(a), priority to, and the benefit of the earlier filing date of, that patent application filed in the Korean Intellectual Property Office on Sep. 8, 2011 and afforded serial number 10-2011-0091220, the contents of which are incorporated by reference herein.

### BACKGROUND OF THE INVENTION

1. Field of the Invention

The present invention relates to the field of terminals and more particularly, to a method of providing a convenient user interface (UI) such that a lock state is changed to a release state.

2. Description of the Related Art

User Interfaces are a technology providing means that a user may communicate with an object, a system, a device, or a program.

To prevent a problem of unintended activation or inactivation that may occur when predetermined lock conditions are satisfied, a portable terminal enters a lock state such that operation of the user interface may be restricted. The terminal in a lock state may receive a click of a button or a touch on a touch screen using a partial UI when a call or alarm occurs. In order to release a lock state of the terminal after a lock screen is displayed on the terminal, a touch gesture previously set on a screen from the user, or an engaged key and password may be input to the terminal.

For example, in a terminal with a touch screen, a user drags a lock image that is displayed on the lock screen to move the lock image and displays a hidden home screen and menu screen. Further, when movement of a touch gesture moves an image along a limited path in a preset direction on a slide bar image is input, the lock screen disappears.

Research for providing convenience and sensitive effect with respect to an operation of the user interface of the terminal for improving the user interface has been performed.

Accordingly, there is a need for efficient user interface capable of convenient operation for the user to remove a lock screen and provide sensitive feedback with respect to an operation of the user.

### SUMMARY OF THE INVENTION

The present invention has been made in view of the above problems, and provides a method of a user interface for intuitively and conveniently releasing a lock state using a touch gesture.

The present invention further provides a method of providing a user interface that may efficiently provide feedback with respect to an operation of the user when controlling a lock state.

In accordance with an aspect of the present invention, a method of providing a user interface includes: displaying on a screen a lock image in a lock state with respect to at least a partial user interface and an object for changing the lock state to a release state; sensing a first contact of a touch gesture on the object; detecting a distance between the object and a second contact of the touch gesture in response to the first contact on the object; and changing the lock state to the release state and removing the lock image from the screen when the distance between the object and the second contact of the touch gesture is greater than a preset threshold. The first contact on the object may be a start contact of the touch gesture.

In accordance with an aspect of the present invention, a method of providing a user interface further includes: displaying an object-set including at least one touch-on object and detecting a distance between the object and a third contact of the touch gesture in response to a first contact on the object; and when the distance between the object and the third contact of the touch gesture is commensurate with one of at least one touch-on distance, applying a visual effect corresponding to the touch-on distance to the object-set to display the applied visual effect on the screen.

In accordance with another aspect of the present invention, an apparatus for providing a user interface includes: a controller displaying a lock image in a lock state with respect to at least a partial user interface and an object for changing the lock state to a release state are; and a touch sensor sensing a first contact of a touch gesture on the object, wherein the controller determines a distance between the object and a second contact of the touch gesture in response to the first contact on the object, and changes the lock state to the release state and removes the lock image from the screen when the distance between the object and the second contact is greater than a preset threshold.

The first contact on the object may be a start contact of the touch gesture, and the second contact may be one of a contact positioned in the most distant location from the object among the contacts of the touch gesture and a final contact of the touch gesture.

The controller displays an object-set including at least one touch-on object and determines a distance between the object and a third contact of the touch gesture in response to the first contact on the object; and applies a visual effect corresponding to the determined touch-on distance to the object-set such that the applied visual effect is displayed on the screen when the distance between the object and the third contact of the touch gesture accords with one of at least one touch-on distances.

In accordance with another aspect of the present invention, a method of providing a user interface includes: displaying on a screen a lock image in a lock state with respect to at least a partial user interface and an object for changing the lock state to a release state; sensing a first contact of a touch gesture on the object; activating a virtual preset touch line having a looped curve shape surrounding the object in response to the first contact on the object; and changing the lock state to the release state and removing the lock image from the screen when a second contact of the touch gesture is located in an area outside of the virtual preset touch line. The first contact of the touch gesture on the object may be an earliest contact of the touch gesture.

In accordance with another aspect of the present invention, a method of providing a user interface further includes: activating at least one virtual touch guide line with a preset location in response to the first contact; maintaining mapping information between the at least one virtual touch guide line and at least one visual effect in a memory; and when the touch gesture contacts one of the at least one virtual touch guide lines, displaying a visual effect corresponding to the contacted virtual touch guide line. The at least one virtual touch guide line having a looped curve shape surrounding the object, and, when the at least one virtual touch guide line includes a first touch guide line and a second touch guide line, the first touch guide line and the second touch guide line do not intersect with each other, and the first touch guide line may be included within an area inside of the second touch guide line. The visual effect corresponding to the contacted virtual touch guide line is that an object set, including at least one touch-on object arranged on or around the contacted virtual touch guide line, appears or to disappears.

The visual effect corresponding to the contacted virtual touch guide line is at least one of a transparency, a color, a luminance, a brightness, a size, a shape, a rotating angle, and a location of an object-set.

In accordance with another aspect of the present invention, a method of providing a user interface further includes: displaying an object-set with at least one touch-on object and activating at least one virtual touch guide line with a preset location in response to a first contact; and, when the touch gesture contacts one of the at least one virtual touch guide lines, applying a visual effect corresponding to the contacted virtual touch guide line to the object-set to display the applied visual effect on the screen. Activating a virtual preset touch line includes: detecting a distance between the object and a second contact of the touch gesture when the virtual preset touch line is a circle having a center on the object; and determining whether the distance between the object and the second contact of the touch gesture is greater than a radius of the virtual preset touch line.

In accordance with another aspect of the present invention, a method of providing a user interface further includes: maintaining the lock state when the second contact of the touch gesture is located in an area inside of the virtual preset touch line.

In accordance with another aspect of the present invention, a method of providing a user interface further includes: executing an application corresponding to the object when the second contact of the touch gesture is located in an area outside of the virtual preset touch line. The lock image may be an image that covers at least one among a main menu screen, a home screen, and an application screen before the lock state. The lock image may be an image of a call event or an image of alarm event, for example.

In accordance with another aspect of the present invention, a method of providing a user interface further includes at least one of: controlling at least one displayed object is disappeared the lock image; and displaying a transparency of the lock image on the screen, in response to the contact on the object.

In accordance with another aspect of the present invention, a method of providing a user interface further includes: activating at least one virtual touch guide region compartmented on the screen in response to a first contact on the object; maintaining mapping information between the at least one virtual touch guide region and at least one visual effect in a memory; and displaying a visual effect corresponding to a virtual touch guide region in which a third contact of the touch gesture is included based on the mapping information when the third contact belongs to one of the at least one virtual touch guide regions. The at least one virtual touch guide region is divided by at least one looped curve surrounding the object, and, when the at least one looped curve includes a first looped curve and a second looped curve, the first looped curve and the second looped curve do not intersect with each other, and the first looped curve may be included in an area inside of the second looped curve. The visual effect corresponding to the contacted virtual touch guide line is that an object set, including at least one touch-on object arranged on or around the contacted virtual touch guide line, appears or to disappears.

The visual effect corresponding to the virtual touch guide region in which the third contact is included is at least one of a transparency, a color, a luminance, a brightness, a size, a shape, a rotating angle, and a location of an object-set.

In accordance with another aspect of the present invention, a method of providing a user interface further includes: displaying an object-set with at least one touch-on object and activating at least one virtual touch guide line with a preset location in response to the first contact; and, when a third contact of the touch gesture is included in one of the at least one virtual touch guide region, applying a visual effect corresponding to the virtual touch guide region in which the third contact is included to the object-set to display the applied visual effect on the screen.

In accordance with another aspect of the present invention, an apparatus for providing a user interface includes: a controller displaying on a screen a lock image in a lock state with respect to at least a partial user interface and an object for changing the lock state to a release state; and a sensor sensing a first contact of a touch gesture on the object, wherein the controller activates a virtual preset touch line having a looped curve shape surrounding the object in response to the first contact on the object; and changes the lock state to the release state and removes the lock image from the screen when a second contact of the touch gesture is located in an area outside of the virtual preset touch line. The first contact of the touch gesture on the object may be an earliest contact of the touch gesture. The controller activates at least one virtual touch guide line with a preset location in response to the first contact; maintains mapping information between the at least one virtual touch guide line and at least one visual effect in a memory; and, when the touch gesture contacts one of the at least one virtual touch guide lines, displays a visual effect corresponding to the contacted virtual touch guide line. The at least one virtual touch guide line has a looped curve shape surrounding the object, and, when the at least one virtual touch guide line includes a first touch guide line and a second touch guide line, the first touch guide line and the second touch guide line do not intersect with each other, and the first touch guide line may be included in an area inside of the second touch guide line. The visual effect corresponding to the contacted virtual touch guide line is that an object set, including at least one touch-on object arranged on or around the contacted virtual touch guide line, appears or to disappears.

The visual effect corresponding to the virtual contacted touch guide line is at least one of a transparency, a color, a luminance, brightness, a size, a shape, a rotating angle, and a location of an object-set. The controller displays an object-set including at least one touch-on object and activates at least one virtual touch guide line with a preset location in response to the first contact; and applies a visual effect corresponding to the virtual touch guide line to display the applied visual effect when the touch gesture contacts one of the at least one virtual touch guide lines. The controller activates the virtual preset touch line by determining a distance between the object and a second contact of the touch gesture when the virtual preset touch line is a circle having a center of the object; and determining whether the distance between the object and the second contact of the touch gesture is greater than a radius of the virtual preset touch line. The controller maintains the lock state when the second contact of the touch gesture is located in an area inside of the virtual preset touch line. The controller executes an application corresponding to the object when the second contact of the touch gesture is located in an area outside of the virtual preset touch line. The lock image may be an image that covers at least one among a main menu screen, a home screen, and an application screen before the lock state. The lock image may be an image of a call event or an image of alarm event, for example. The controller may perform at least one of removing the lock image displayed on the screen; and controlling a transparency of the lock image displayed on the screen, in response to the contact on the object. The controller may activate at least one virtual touch guide region on the screen in response to the first contact on the object; maintain mapping information between the at least one virtual touch guide region and at least one visual effect in a memory; and display a visual effect corresponding to a virtual touch guide region in which a third contact of the touch gesture is included based on the mapping information when the third contact belongs to one of the at least one virtual touch guide region. The at least one virtual touch guide region is divided by at least one looped curve surrounding the object, and, when the at least one looped curve includes a first looped curve and a second looped curve, the first looped curve and the second looped curve do not intersect with each other, and the first looped curve may be included in an area inside of the second looped curve. The visual effect corresponding to the virtual touch guide region, in which the third contact is included, is that an object set, including at least one touch-on object arranged on or around the contacted virtual touch guide line, appears or to disappears.

The visual effect corresponding to the virtual touch guide region in which the third contact is included is at least one of a transparency, a color, a luminance, a brightness, a size, a shape, a rotating angle, and a location of an object-set. The controller displays an object-set with at least one touch-on object and activates at least one virtual touch guide line with a preset location in response to the first contact, and applies a visual effect corresponding to the virtual touch guide region in which the third contact is included to the object-set to display the applied object-set on the screen when a third contact of the touch gesture is included in one of the at least one virtual touch guide regions.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of an apparatus for providing a user interface according to an exemplary embodiment of the present invention;

FIG. 2 is a diagram illustrating an example of a virtual touch line according to an embodiment of the present invention;

FIG. 3 is a diagram illustrating an example of a lock screen according to an embodiment of the present invention;

FIG. 4 is a diagram illustrating an example of a virtual touch line for displaying a visual effect according to an embodiment of the present invention;

FIG. 5 is a diagram illustrating an example of a virtual touch guide region for displaying a visual effect according to an embodiment of the present invention;

FIG. 6 is a diagram illustrating an example of a screen on which a visual effect is displayed as feedback with respect to a touch gesture according to an embodiment of the present invention;

FIG. 7 is a diagram illustrating another example of a screen on which a visual effect is displayed as feedback with respect to a touch gesture according to an embodiment of the present invention;

FIG. 8 is a diagram illustrating a further example of a screen on which a visual effect is displayed as feedback with respect to a touch gesture according to an embodiment of the present invention;

FIG. 9 is a diagram illustrating another example of a screen on which a visual effect is displayed as feedback with respect to a touch gesture according to an embodiment of the present invention;

FIG. 10 is a diagram illustrating an example of a screen on which a visual effect is displayed according to an embodiment of the present invention;

FIG. 11 is a diagram illustrating another example of a screen on which a visual effect is displayed according to an embodiment of the present invention;

FIG. 12 is a diagram illustrating an example of a screen on which a visual effect is displayed according to another embodiment of the present invention;

FIG. 13 is a diagram illustrating an example of a virtual touch guide line for displaying a visual effect according to another embodiment of the present invention;

FIG. 14 is a diagram illustrating another example of a virtual touch guide line for displaying a visual effect according to another embodiment of the present invention;

FIG. 15 is a diagram illustrating an example of a screen on which a visual effect is displayed according to another embodiment of the present invention;

FIG. 16 is a diagram illustrating an example of a screen on which a visual effect is displayed according to another embodiment of the present invention;

FIG. 17 is a schematic diagram sequentially illustrating a procedure of changing from a lock state to a release state in response to a touch gesture;

FIG. 18 is a flowchart illustrating a method of providing a user interface according to an embodiment of the present invention;

FIG. 19 is a flowchart illustrating a method of providing a user interface according to another embodiment of the present invention; and

### DETAILED DESCRIPTION OF THE INVENTION

Exemplary embodiments of the present invention are described with reference to the accompanying drawings. The same reference numbers are used throughout the drawings to refer to the same or like parts. Detailed descriptions of well-known functions and structures incorporated herein may be omitted to avoid obscuring the subject matter of the present invention.

Hereinafter, a method of manufacturing and using the present invention will be described. In the specification, a touch gesture is performed by at least one finger, such as thumb or index finger, or a tool, such as touch pen or stylus, and may be received by a touch pad, a touch screen, a touch sensor, or a motion sensor as input information by the user. Here, it will be noticed that the touch gesture includes a flick, a swipe, a tap & flick, or a hold & flick. An apparatus for providing a user interface (referred to as ‘UI’ hereinafter) according to an embodiment of the present invention may be used in a user terminal such as TV, computer, cellular phone, smart phone, kiosk, printer, scanner, e-book or multimedia player. Further, it will be noticed that the apparatus for providing a UI may be used in a device, a touch screen controller, or a remote controller including a touch screen, a touch pad, a touch sensor, or a motion sensor and is not limited to a specific form.

The apparatus for providing a UI or a terminal with the apparatus for providing a UI (referred to as ‘terminal’ hereinafter) may have a plurality of UI states. For example, the plurality of UI states may include a lock state and a release state with respect to at least a partial UI. In a case of the lock state, power to a terminal is turned-on and operation of the terminal is possible, but most, if not all of user inputs, may be disregarded, as the terminal may be in a locked state in this initial turn-on phase. In this case, no operation in the terminal is performed in response to a user input or performing a predetermined operation may be prohibited. The predetermined operation may include activation or inactivation of a predetermined function corresponding to a UI, movement and/or selection between UIs, for example. The lock state may be used to prevent unintended or unauthentic utilization of the terminal, or activation or inactivation of a function of the terminal. For example, so as to change at least a partial UI in the terminal from a lock state to a release state, the terminal may respond to restrictive user inputs including inputs corresponding to a power on/off button and a home button of the terminal. The terminal in a lock state may respond to a user input corresponding to an attempt to change to a release state or an attempt of turning-off power of the terminal. However, the UI may not respond to a user input corresponding to movement and/or a selection attempt between the UIs. Although a user input is disregarded in the terminal, the terminal may provide sensing feedback, such as visual, audible, or vibration feedback, when a disregarded input is detected.

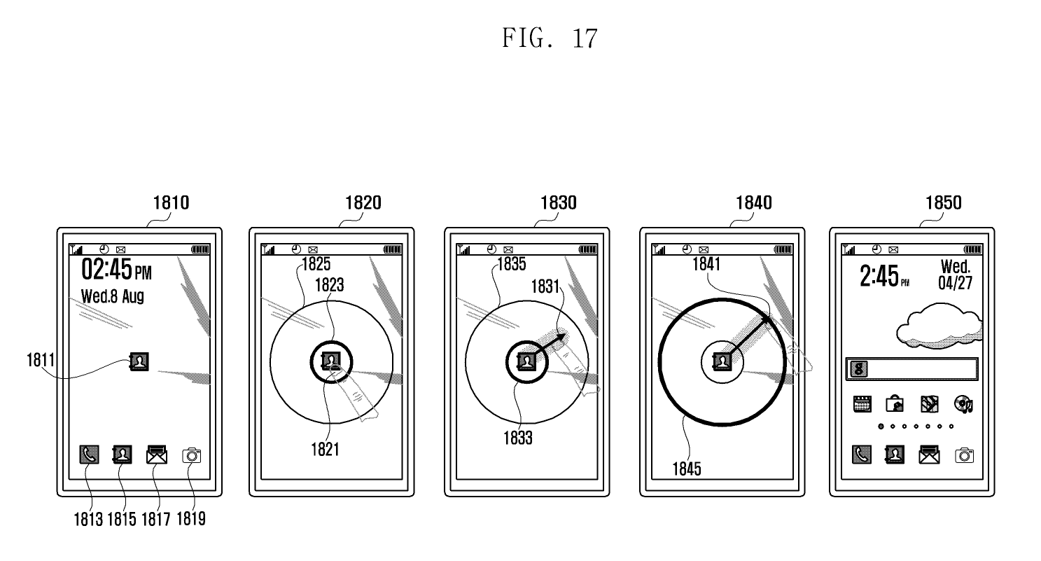

When the terminal includes a touch screen, an operation responding to an input on a touch screen may be prohibited. For example, operations such as a movement and/or a selection between UIs may be prohibited while the terminal is in a lock state. That is, a touch or contact of a touch gesture in a locked terminal may be disregarded or not operated upon. However, the locked terminal may respond to contact of a limited range on the touch screen. The limited range includes contact determined by the terminal corresponding to an attempt at changing a part of user interface from a lock state to a release state. For example, the limited range may include a first contact 1821 of a touch gesture on an object 1811 of screen 1820, which is in a lock mode, in FIG. 17. The release state allows for a general operation of the terminal, and the terminal may detect and respond to user inputs corresponding to a mutual action of the user interface. A released terminal may detect and respond to user inputs for movement and/or selection between UIs, input of data, activation and inactivation of a function, etc.

A touch gesture according to an embodiment of the present invention may be a set of contacts having a movement trace. For example, when the touch gesture has a shape of a line with a movement trace, one point on the movement trace or one location on the line may be referred to as a contact. The apparatus for providing the user interface may detect contacts continuously located on the touch screen by a touch gesture, such as a flick, a swipe, a tap & flick, or a hold & flick. For example, the apparatus for providing the user interface may detect a set of contacts of a dotted line form corresponding to a touch gesture by adjusting sensitivity of a touch sensor (e.g., the number of contacts sensed per hour or other period of time). The apparatus for providing the user interface may detect only a start contact of a touch gesture (i.e., the earliest contact of a touch gesture) and/or a final contact of a touch gesture (i.e., the latest contact of the touch gesture) according to the implementation.

Referring to FIG. 17, the apparatus for providing the user interface according to an embodiment, the following is a description of a procedure of changing lock screens 1810 to 1840 from a lock state to a screen 1850 in a release state. The lock screen 1810 may include a lock image 1811 and objects, 1813, 1815, 1817, and 1819. Here, the object 1811 may have various forms such as an icon, a still image, and/or an animation. Further, the objects 1813, 1815, 1817, and 1819 may represent icons corresponding to an application that may be executed when the lock state is changed to the release state. For example, the object 1813, the object 1815, the object 1817, and the object 1819 may be icons corresponding to a phone, a contact list, a message, and a camera, respectively.

When a first contact 1821 of a touch gesture is sensed on an object 1811 of lock screen 1820, an object-set including at least one touch-on objects 1823 and 1825 may be displayed (screen 1820). When a second contact 1841 of the touch gesture passes through a virtual preset touch line 1845 (screen 1840), the apparatus for providing UI operates such that the lock state is changed to a release state, and the lock image 1811 disappears and a screen 1850 appears. Further, the apparatus for providing the user interface may operate such that a visual effect is applied to at least one touch-on object 1823 according to a third contact 1831 of a touch gesture on a lock screen 1830 to display touch-on objects 1833 and 1835.

Here, the first contact 1821, the second contact 1841, and the third contact 1831 are contacts included in the same touch gesture within a movement trace. For example, the first contact 1821 may be a start contact (the earliest contact) of a touch gesture. Further, the first contact 1821 may be a contact earlier than the second contact 1841 and the third contact 1831 of a touch gesture. The second contact may be a final contact (a last contact) of the touch gesture or a contact positioned in a most distant location from the object 1811. Further, the second contact 1841 may be a contact on a virtual preset touch line 145 having a closed curve shape, one of contacts included in a touch gesture providing an event changing from an area inside of a virtual preset touch line 145 to an area outside of the virtual touch line 145 or from an area outside to an area inside of the virtual touch line 145, or one of contacts of a touch gesture belong to a region that may be determined as one of inside or outside of the virtual preset touch line 145. The third contact 1831 may be one of the contacts sensed by the apparatus for providing a user interface before the lock image disappears. Here, the third contact 1831 shown in FIG. 17, screen 1830, is an example of a contact detected at an earlier time than the second contact 1841. However, the second contact 1841 and the third contact 1831 may occur regardless of a time order according to the implementation. For example, after the second contact 1841 is sensed, the apparatus for providing the user interface may determine whether the second contact 1841 is included in an area inside or an area outside of virtual preset touch line 145. In this case, presence of a release of the lock state is determined, and a next operation of the apparatus with respect to determination of presence of the release of the lock state may be performed after a preset time. If a third contact 1831 is sensed for a preset time after determining presence of the release of the lock state, a visual effect corresponding to the third contact 1831 may be provided. The virtual preset touch line may be set in a procedure of manufacturing an apparatus for providing a user interface or a terminal using the apparatus for providing the user interface. Moreover, the virtual preset touch line may be determined by a statistic or an experimental method for convenience of the UI. Further, the virtual preset touch line may be set by a user of the apparatus for providing the user interface and a terminal.

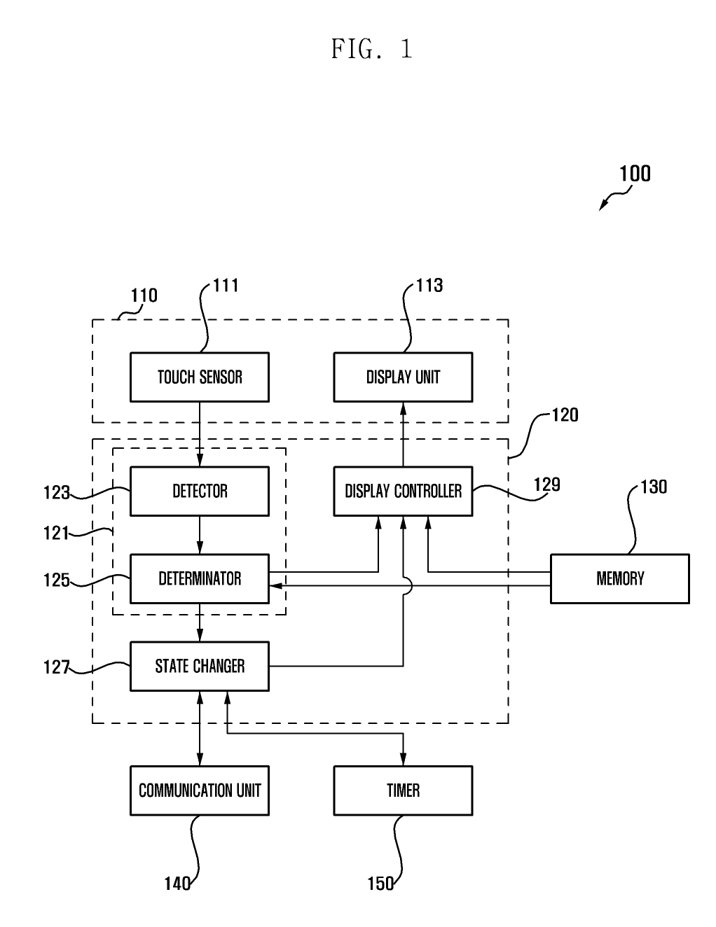

An apparatus for providing the user interface according to an embodiment of the present invention is described with reference to FIG. 1 to FIG. 3.

The apparatus 100 for providing a user interface of FIG. 1 includes a controller 120 and a touch sensor 111. The controller 120 controls a display of a lock image when the terminal is a lock state with respect to at least a part of a UI and the display of an object for changing the lock state to a release state. The touch sensor 111 senses a first contact of a touch gesture on the object.

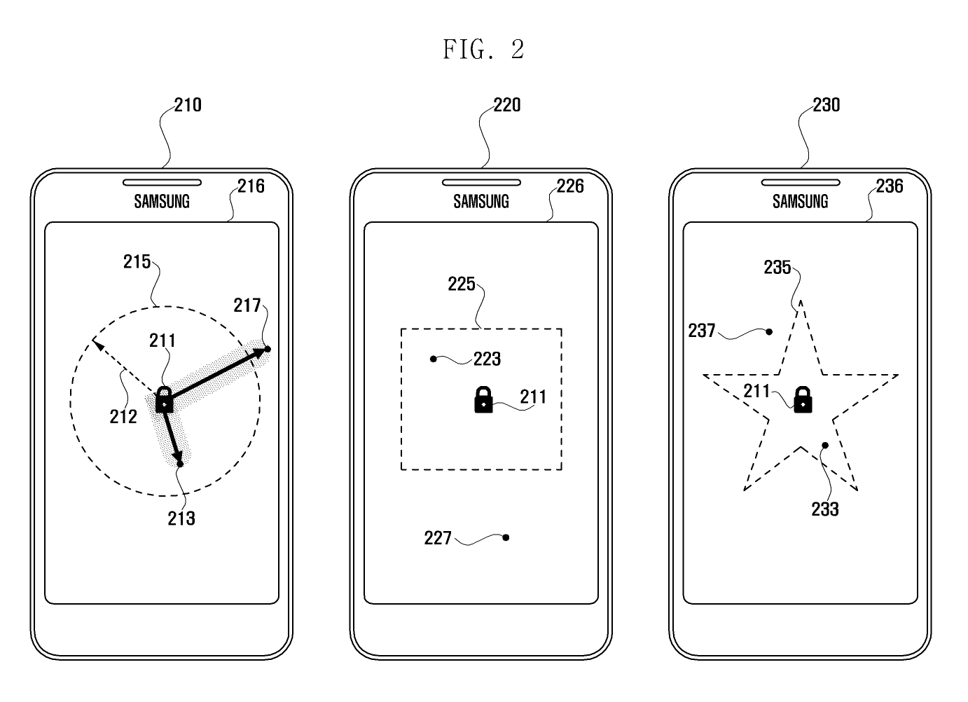

Here, for example, the controller 120 may activate virtual preset touch lines 215, 225, and 235 (see FIG. 2) having a looped curve shape surrounding the object 211 in response to the first contact on the object 211 of screens 216, 226, and 236, respectively, in terminals 210, 220, and 230 of FIG. 2. When the virtual preset touch line 215 is a circle with a center at object 211, the controller 120 determines a distance between the object 211 to a second contact of a touch gesture, and determines whether the distance between the first contact and the second contact is greater than a radius of the virtual preset touch line to activate the virtual preset touch line 215. Here, the virtual preset touch lines 215, 225, 235 may not be displayed according to an implementation of the invention or an object similar to a shape of the virtual preset touch lines 215, 225, 235 shown in FIG. 2 may be displayed.

When the second contact of the touch gesture is located in area 217, 227, 237, which are outside of the corresponding virtual preset touch lines 215, 225, 235, the controller 120 operates such that the lock state is changed to a release state and the lock image is removed from the screens 216, 226, and 236. Further, in a case where the virtual preset touch line 215 is a circle with a center at object 211, when a distance between the object 211 and the second contact is greater than a preset threshold 212, the controller 120 may operate such that the lock state is changed to the release state and the lock image is removed from the screen 216.

When the second contact of the touch gesture is located in areas 217, 227, and 237, which are outside of corresponding virtual preset touch lines 215, 225, and 235, the controller 120 may operate such that an application corresponding to the object 211 is executed, when the object 211 is an icon corresponding to the application.

For example, when a first contact of a touch gesture is sensed on an object 1815, which is an icon corresponding to a phone book application, in FIG. 17, a virtual preset touch line having a circle centered of an object 1815 may be activated. When the second contact of the touch gesture is located in a region outside of the virtual preset touch line, the controller 120 may operate to unlock (release) the terminal and a phone book application corresponding to the object 1815 is executed.

Returning to FIG. 2, when the second contact of the touch gesture is located within the area of 213, 223, 233 of a virtual preset touch line, the controller 120 may operate such that a lock state is maintained.

As illustrated previously, because the apparatus 100 for providing user interface controls a lock state based on a location or a distance of a contact of a touch gesture without restricting a path or direction of a movement trace of the touch gesture, it provides a convenient means for unlocking and executing an application concurrently.

Returning to FIG. 1, the controller 120 may include an activation unit 121, a state changer 127, and/or a display controller 129. The activation unit 121 may include a detector 123 and/or a determinator 125.

The touch sensor 111 may transmit data (e.g., contact location of touch gesture) of a sensed touch gesture to the detector 123 of the activation unit 121.

When a first contact of the touch gesture is sensed on the object 211 (FIG. 2), the detector 123 may detect a second contact of a touch gesture from data of the received gesture. The determinator 125 may access information about the virtual preset touch lines 215, 225, and 235 maintained in a memory 130 and determine whether a second contact of the touch gesture is located in an area outside of the virtual preset touch lines 215, 225, and 235.

Further, when the virtual preset touch line 215 is a circle, the detector 123 may determine a distance between the object 211 and the second contact of the touch gesture. The determinator 125 may determine whether the determined distance is greater than a radius 212 of the virtual preset touch line. When the detected distance is greater than radius 212 of the virtual preset touch line, the determinator 125 may transmit an interrupt signal to the state changer 127 as a “state change event.”

When receiving an interrupt signal from the detector 123, the state changer 127 may operate such that a lock state of at least a part of the UI is changed to a release state. Moreover, the state changer 127 may transmit a command to the display controller 129 such that a lock image displayed on the display unit 113 is removed from the screen.

In addition, the “state change event” interrupt signal received by the state changer 127 may be transmitted from a communication unit 140 or a timer 150. For example, when a call is received in a lock state of a terminal, the communication unit 140 may transmit the interrupt signal to the state changer 127. The state changer 127 may control the display controller 129 or an input module such that a lock state of the terminal is switched to a release state to place the terminal in a release mode. In addition, when a call receiving request is input or a driving request of an application corresponding to an object of FIG. 17 on a lock screen with respect to generation of the call, the state changer 127 may operate such that a lock state is released and an application associated with the communication unit 140 is executed and a driving request signal to execute the application is transmitted to the communication unit 140.

Alternatively, a timer 150 may transmit an interrupt signal with respect to an alarm event and an event regarding the expiration of a preset time to the state changer 127 for changing from an idle state to a lock state. Further, the state changer 127 may change a release state to a lock state according to the interrupt signal received from the timer 150. The state changer 127 may transmit a reset signal with respect to the expiration of a preset time and a reset signal to the timer 150.

The display controller 129 may receive a control signal from the determinator 125 and/or the state changer 127, and operate to provide a visual effect as a feedback with respect to a switch between a lock screen displayed on the display unit 113 and a release screen or user operation. For example, the display controller 129 may access a visual effect according to a virtual touch guide line (or virtual touch guide region) maintained in a memory 130 on lock screens 1820 to 1840 of FIG. 17. The visual effect is applicable to an object-set including at least one touch-on object. The at least one touch-on object is an action in which the touch gesture contacts a virtual touch guide line (or virtual touch guide region) in a preset location, respectively, and a visual effect is then applied.

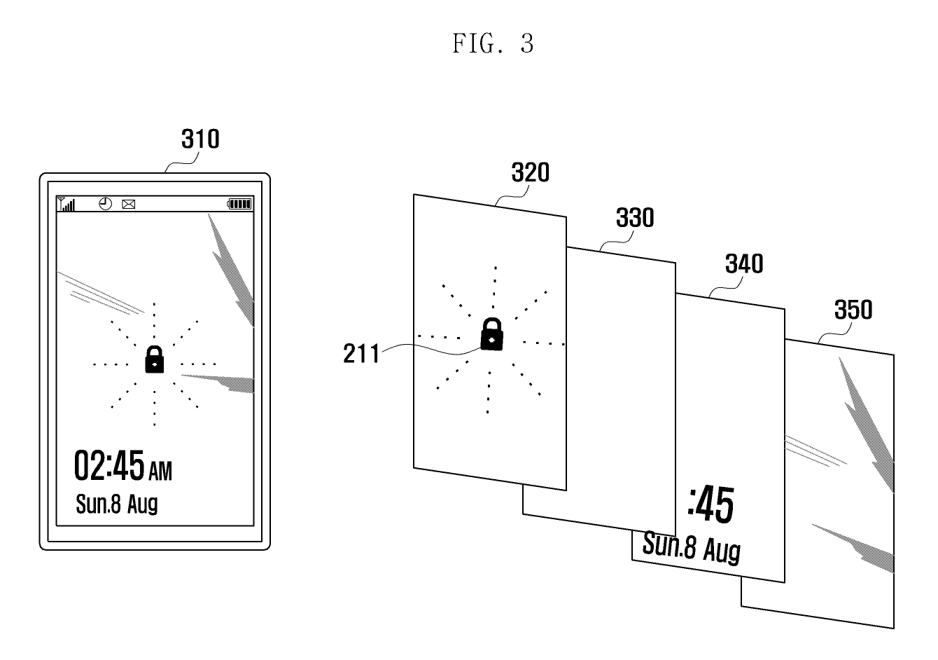

Furthermore, the display controller 129 may operate such that a lock screen 310 of FIG. 3 is displayed. For example, the lock screen 310 may be configured as layers 320, 330, 340, and 350. A layer 340, indicating weather, time, and event, may be displayed on the lock layer 350. Here, the lock layer 350 may include an image covering at least one of a screen of a main menu, a home screen, and an application screen before the lock state. Further, the lock image may include an image when a call event is generated or an image when an alarm event is generated. Furthermore, the display controller 129 may operate such that an opaque level is adjusted using an opaque layer (or transparent layer) 330 on the object layer 340 to highlight the lock layer 350 and/or an object 211 on the object layer 340 and object-set 320. Further, the display controller 129 may perform at least one of an operation such that an object 211 and an object-set 320, or an object layer 340, except for the object 211, disappears from the lock layer 350 or an operation of controlling opacity (or transparency) in which a lock layer 350 is displayed on the screen.

The apparatus 100 for providing a user interface may further include a display unit 113 (FIG. 1). The display unit 113 may include a screen display module such as Cathode Ray Tube (CRT), Liquid Crystal Display (LCD), Plasma Display panel (PDP), Light emitting Diode (LED), Light emitting Polymer Display (LDP) or Organic Light Emitting Diode (OLED).

Further, the display unit 113 and the touch sensor 111 may be combined as a touch screen 110. The touch sensor 111 may be provided in a front surface or a rear surface of the display module, and in the same location as that of the screen. It is known that a capacitive technology, a resistive technology, an infrared technology, or a surface acoustic wave technology are applicable in touch sensor technology, and the touch sensor 111 may be provided in a front surface or a rear surface of the display.

Moreover, the apparatus 100 for providing a user interface may further include a memory 130. The memory 130 may store information with respect to the virtual preset touch lines 215, 225, and 235 (FIG. 2). For example, information with respect to the virtual preset touch line 215 of FIG. 2 may include the size of radius 212. Further, the memory 130 may maintain at least one virtual touch guide line and at least one mapping information of a visual effect. The memory 130 may be implemented using a memory or a hard disc in various forms such as a volatile memory or a non-volatile memory.

Further, the apparatus 100 for providing the UI may further include a communication unit 140 and/or a timer 150. The communication unit 140 may be a communication module capable of receiving messages, data, calls, and the like. When a call is received in a lock state, the communication unit 140 may transmit an interrupt signal to the state changer 127. The timer 150 may transmit an interrupt signal to the state changer 127 with respect to an alarm event or an event regarding the expiration of a predetermined preset time for changing the terminal state to an idle state or a lock state, as previously discussed.

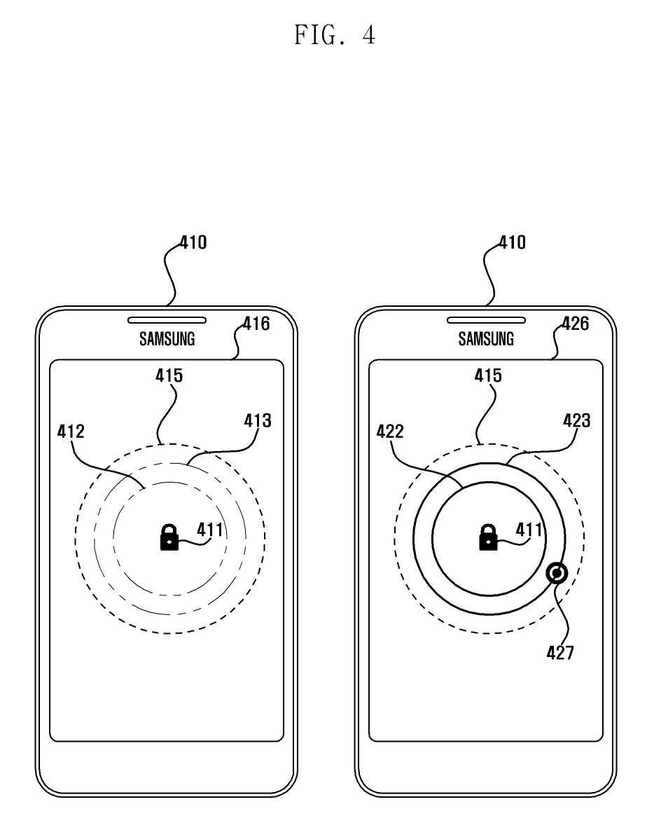

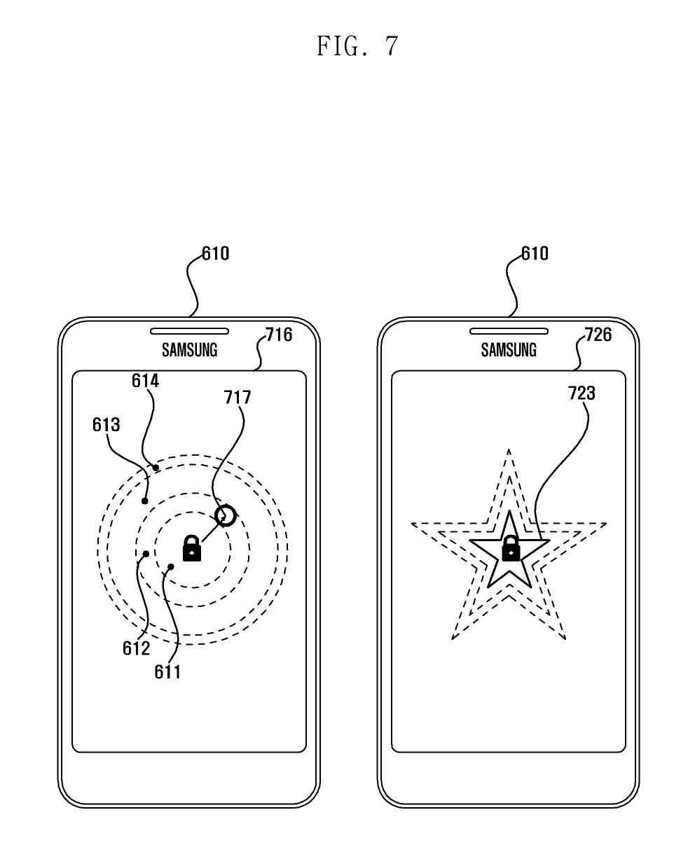

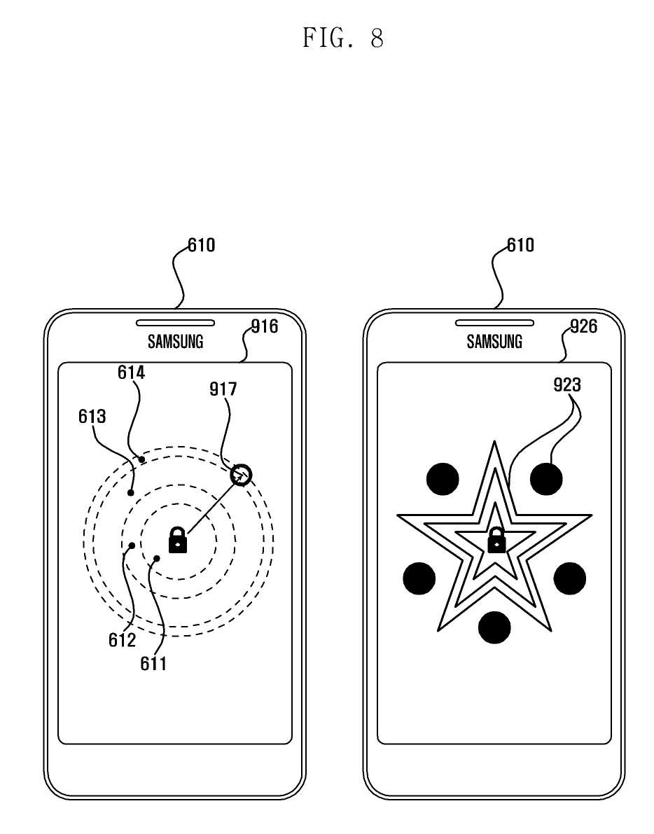

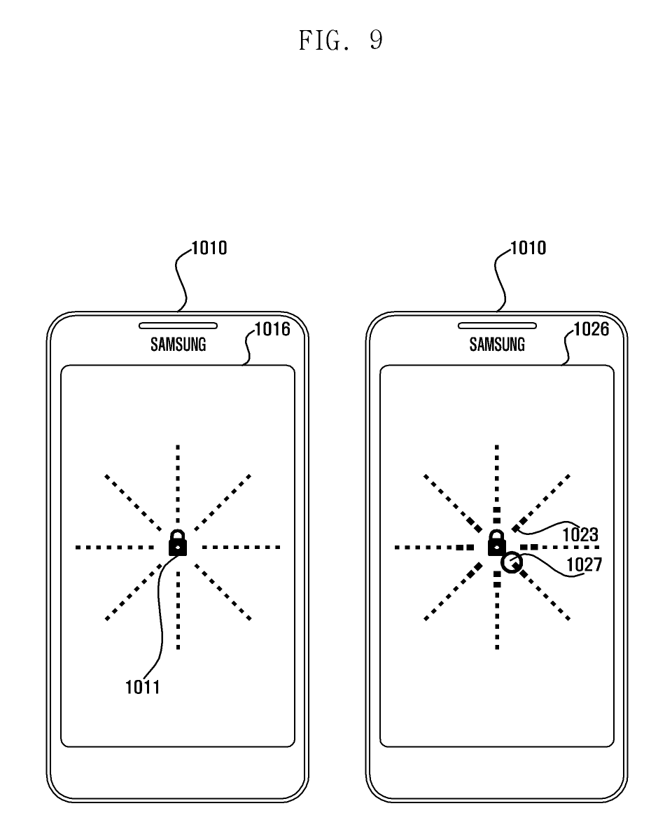

A method of providing feedback with respect to a user operation for controlling a lock state in an apparatus for providing a UI according to an embodiment of the present invention will be described with reference to FIG. 4 to FIG. 16. The feedback may include a visual effect, an audible effect, a touch effect, and the visual effect will be now described in detail.

A visual effect may be provided as an action with respect to the touch gesture may include a method of not considering a direction of a movement trace with respect to contacts of a touch gesture (effect regardless of direction) and/or a method of considering the direction (effect associated with direction). Further, the visual effect is an approach for determining a presence of generation of a touched-on event by a touch gesture, and may include an approach using a virtual touch guide line and/or an approach using a virtual guide region. Here, a visual effect provided as a response with respect to a touch gesture, a touch-on object, an object-set, a virtual touch guide line, or virtual guide region may be set in a manufacturing procedure or may be determined by the user. Further, the terminal may provide a user interface that allows a user to select or change a visual effect, a touch-on object, an object-set, a virtual touch guide line, or a virtual touch guide region.

An effect regardless of a direction according to an embodiment of the present invention will be described with reference to FIG. 4 to FIG. 11.

FIG. 4 illustrated a concept in which an effect regardless of a direction using a virtual touch guide line is displayed according to an embodiment of the present invention. In a terminal 410 with an apparatus 100 for providing a UI, a screen 416 may be displayed as a response to a first contact on the object 411. In this case, the virtual preset touch line 415 may be activated. In response to the first contact on the object 411, the controller 120 of FIG. 1 may activate at least one virtual touch guide lines 412 and 413, and operate such that mapping information between the at least one virtual touch guide lines 412 and 413 and at least one visual effects 422 and 423 are maintained in a memory 130. In this case, a touch-on object or an object-set may be displayed, or not, on the at least one virtual touch guide lines 412 and 413. When the touch gesture (427) contacts one of at least one virtual touch guide lines 412 and 413, the controller 120 may operate such that a visual effect 423 corresponding to a virtual touch guide line 413, for example, contacted based on the mapping information, is displayed on the screen 426. Here, each of the at least one virtual touch guide lines 412 and 413 may have a preset location on screens 416 and 426. When each of the at least one virtual touch guide lines 412 and 413 has a looped curve shape surrounding an object 411 and the at least one virtual touch guide lines 412 and 413 include a first touch guide line 412 and a second touch guide line 413, the first touch guide line 412 and the second touch guide line 413 may not cross but the first touch guide line 412 may be included within the second touch guide line 413. Here, a visual effect 423 corresponding to a contacted virtual touch guide line 413 may be one that an object set, including at least one touch-on object arranged on or around the virtual touch guide line 413, appears (i.e., 423) or to disappears.

Further, the visual effect may be a case where at one of a transparency, color, a luminance, a brightness, a size, a shape, a rotating angle, and a location of an object-set.

Further, the controller 120 may display an object-set including at least one touch-on object on a screen 416, and activate at least one virtual touch guide lines 412 and 413 in response to a first contact on the object 411. When the touch gesture contacts one of the at least virtual touch guide lines 412 and 413, the controller 120 may operate such that a visual effect 423 corresponding to the contacted virtual touch guide line 413 is applied to an object-set to display the applied visual effect on screen 426.

Further, when the at least virtual touch guide lines 412 and 413 are a circle having a center at object 411, the controller 120 may display an object-set including at least one touch-on object in response to a first contact on the object 411. The controller 120 determines a distance between the object 411 and a third contact 427 of a touch gesture. When the distance between the object and the third contact 427 is commensurate with one of at least touch-on distances, the controller 120 may operate such that a visual effect 423 corresponding to the touch-on distance is applied to the object-set to display the applied visual effect on the screen 426.

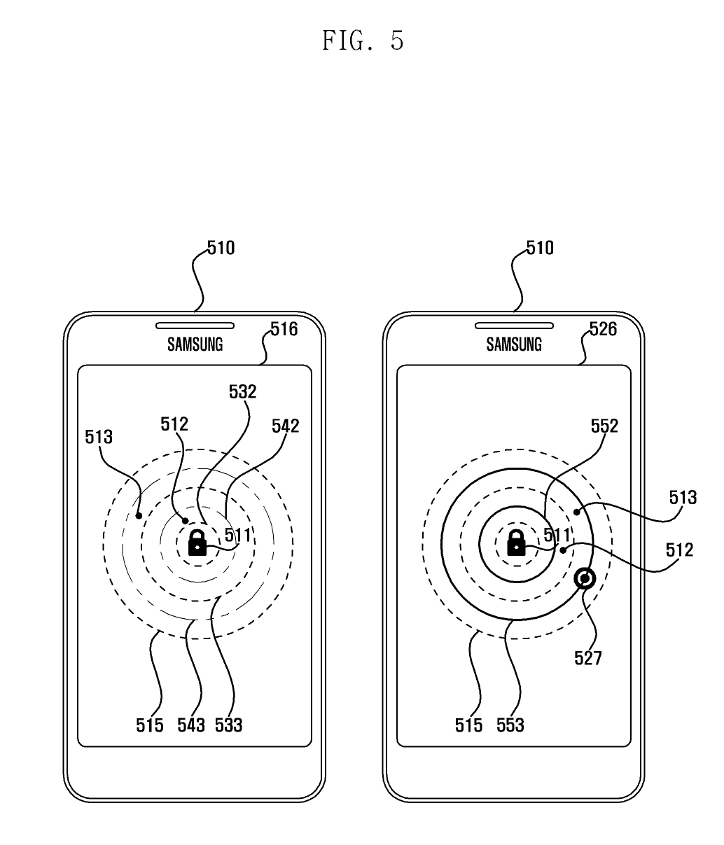

FIG. 5 illustrates a concept in which an effect regardless of a direction is displayed using a virtual touch guide region according to an embodiment of the present invention. In the terminal 510, a screen 516 may be displayed in response to the first contact on the object 511. In this case, a virtual preset touch line 515 may be activated. The controller 120 may activate at least one virtual touch guide regions 512 and 513 in response to a first contact on the object 511 and operate such that mapping information of the at least virtual touch guide regions 512 and 513 and corresponding visual effects 552 and 553 are maintained in the memory 130. When third contact 527 of a touch gesture is included in one of the at least virtual touch guide regions 512 and 513, the controller 120 may operate such that a visual effect 553, corresponding to virtual touch guide region 513 in which the third contact 527 is included based on the mapping information, is displayed. Here, the at least one virtual touch guide regions 512 and 513 may be a region presented on screens 516 and 526, respectively. For example, the at least one virtual touch guide regions 512 and 513 are be presented by at least one looped curve 532, 533, and 515 surrounding an object 511. When the at least looped curves 532, 533, and 515 include a first looped curve 532 and a second looped curve 533, the first looped curve 532 and the second looped curve 533 may not cross each other. However, the first looped curve 532 may be included inside the second looped curve 533. Similarly, the second looped curve 533 may be included inside the virtual preset touch line 515.

Moreover, in response to a first contact on the object 511, the controller 120 may display object-sets 542 and 543 including at least one touch-on object, and activate at least one virtual touch guide region 512 and 513. When third contact 527 of a touch gesture is included in one region 513 of the at least one virtual tough guide regions 512 and 513, the controller 120 applies a visual effect corresponding to a virtual touch guide region 513 in which the third contact 527 is included to an object-set and the visual effect is displayed (553) on the screen 526. Here, the at least touch guide regions 512 and 513 may be regions previously presented on the screens 516 and 526, respectively.

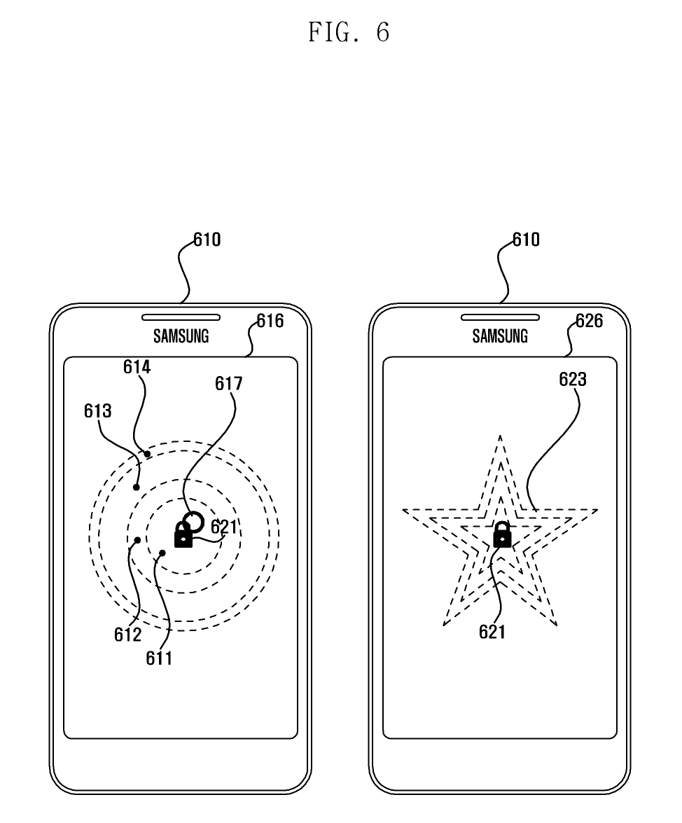

FIG. 6 to FIG. 9 sequentially illustrate a procedure of displaying an effect regardless of a direction using a virtual touch guide region according to an embodiment of the present invention. Screens 616, 716, 816, 916 of the terminal 610 indicate at least one virtual touch guide region 611, 612, 613, 614 and third contacts 617, 717, 817, and 917 on a movement trace of the touch gesture. When the third contacts 617, 717, 817, and 917 of a touch gesture are included in virtual touch guide regions 611, 612, 613, and 614, screens 626, 726, 826, and 926 of the terminal 610 express object-sets 623, 723 and 923 to which virtual effects corresponding to virtual touch guide regions 611, 612, 613, 614 are applied. In this case, the visual effects change the dashed lines shown to solid lines to show the progression of the touch gesture. Moreover, in response to a first contact of a touch gesture on the object 621, a touch-on object or an object-set 623 may be displayed, or not displayed (e.g., represented by dashed lines), on the screen 626. In addition, the visual effect is applied to virtual touch guide regions 611, 612, 613, and 614 or object-sets 623, 723 and 923 corresponding to a virtual touch guide region. However, the visual effect is not limited to ranges of the virtual touch guide regions 611, 612, 613, 614 or a location of the virtual touch guide line but may be displayed as shown on screens 626, 726, 826, 926 (i.e., solid lines). Accordingly, an apparatus for proving a user interface may express a visual effect in various forms as feedback with respect to a user operation, and stimulates the user. Here, the visual effect applied to the object-sets 623, 723, 923 may be a case where at least one of a transparency, a color, a luminance, a brightness, a size, and a shape is changed.

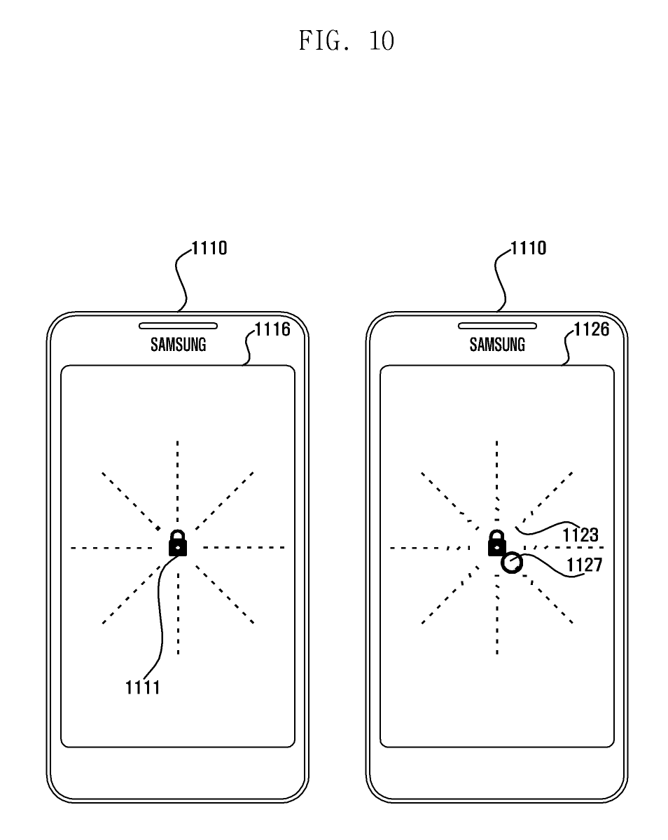

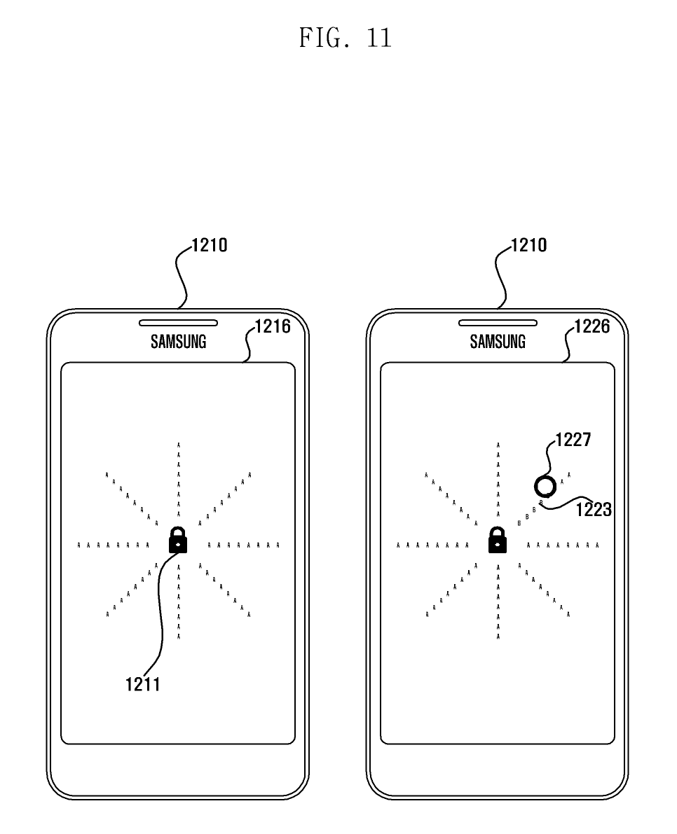

FIG. 10 and FIG. 11 illustrate screens displaying an effect regardless of a direction according to an embodiment of the present invention.

In response to a first contact of a touch gesture on an object 1011 of a screen 1016 of a terminal 1010 in FIG. 10, an object-set including a touch-on object may be displayed on a screen 1016. For example, the object-set may include touch-on objects in the form of points, and may have a shape of dotted lines extending from object 1011. Here, the touch-on objects may have various forms such as an arrow shaped image or a wave shaped animation instead of a dotted form. A visual effect may be applied to a touch-on object 1023 corresponding to a virtual touch guide line location in a third contact of a touch gesture or a virtual touch guide region and displayed on a screen 1026. Here, the visual effect may be a case where a touch-on object 1023 and/or an object-set appear, or disappear, or a case where at least one of a transparency, a color, a luminance, a brightness, a size, and a shape of the touch-on object 1023 and/or the object-set is changed.

In response to a first contact of a touch gesture on an object 1111 (FIG. 11) of the screen 1116 of the terminal 1110, an object-set of a broken line form including a touch-on object of a short line shape may be displayed on a screen 1116. A visible effect may be applied to a touch-on object 1123 corresponding to a virtual touch guide line location in a third contact 1127 of a touch gesture or a virtual tough guide region and displayed on the screen 1126. Here, the visual effect may be a changed rotation angle of a touch-on object-set and/or an object included in an object-set.

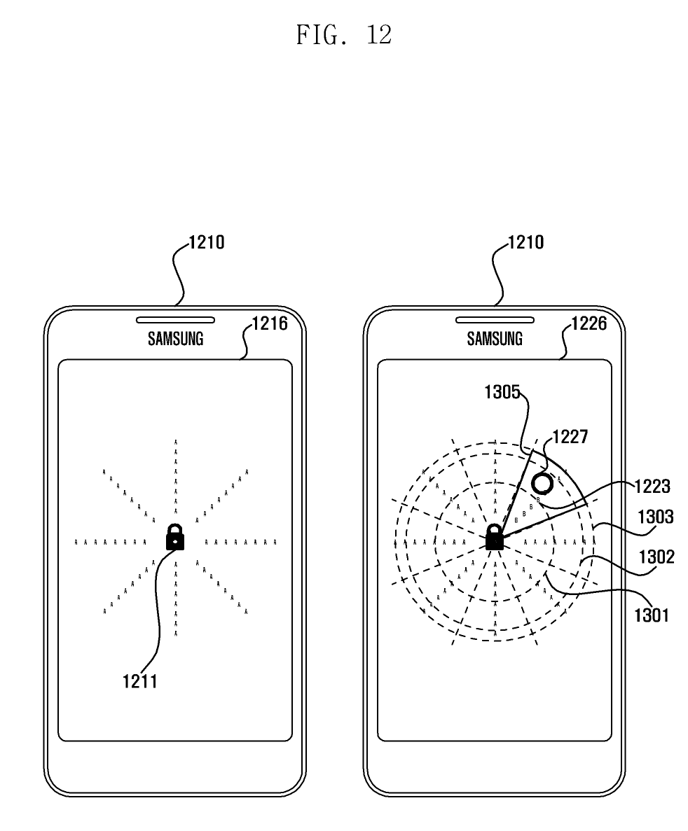

An effect associated with a direction according to another embodiment of the present invention will be described with reference to FIG. 12 to FIG. 16.

In response to a first contact of a touch gesture on an object 1211 of the screen 1216 of the terminal 1210 in FIG. 12, an object-set including a touch-on object including a plurality of ‘A’ shape objects may be displayed on the screen 1216. A visual effect may be applied to a touch-on object 1223 corresponding to a virtual touch guide line location in a third contact of a touch gesture or a virtual touch guide region and displayed on the screen 1226. For example, the visual effect may be a case where a shape of a touch-on object 1223 included in a queue of touch-on objects located relatively near to a third contact 1227 of a touch gesture is changed from an ‘A’ shape to a ‘B’ shape (1223).

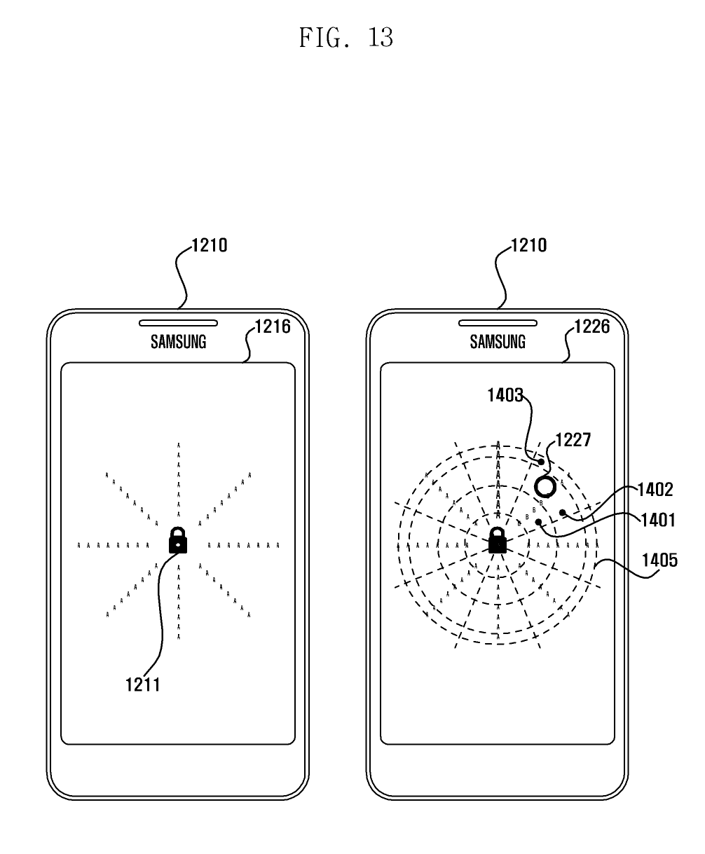

FIG. 13 is a concept diagram illustrating at least one touch guide lines 1301, 1302, 1303 and a virtual direction region 1305 of a circular sector shape for implementing an effect associated with a direction shown in FIG. 12. For example, in response to a first contact of a touch gesture on the object 1211, the controller 120 may activate at least one touch guide line 1301, 1302, 1303 and the virtual direction region 1305 of a circular sector shape. The memory 130 may store at least one visual effect mapped to at least one touch guide line 1301, 1302, 1303 for each virtual direction region 1305. The controller 120 may distinguish a virtual direction region 1305 to which a third contact 1227 of a touch gesture from a virtual touch guide line 1302 contact associated with the touch gesture. The controller 120 may operate such that a visual effect corresponding to the distinguished virtual direction region 1305 and touch guide line 1302 is applied to a touch-on object 1223 based on mapping information maintained in the memory 130.

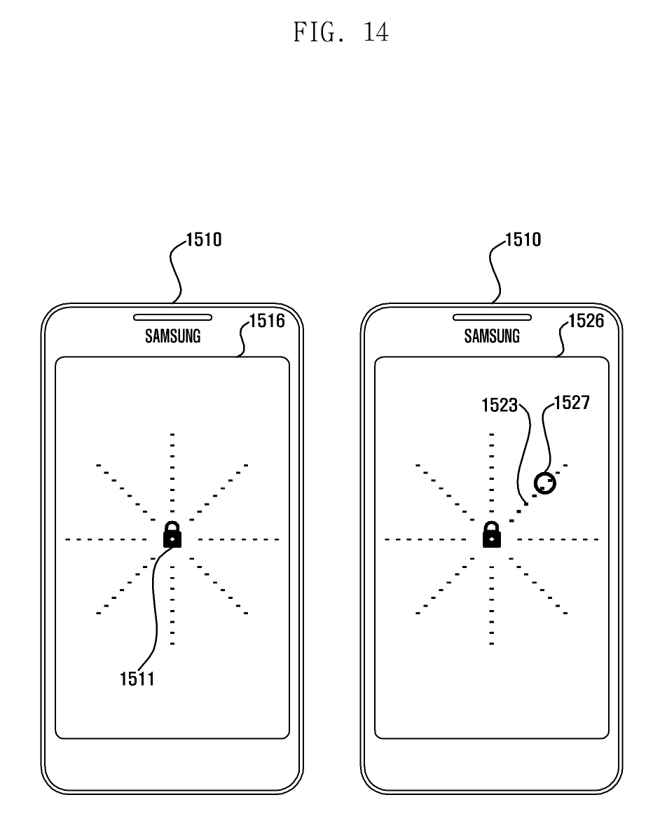

Further, FIG. 14 is a concept diagram illustrating at least one touch guide region 1401, 1402, and 1403 for implementing an effect associated with a direction shown in FIG. 12. For example, at least one touch guide region 1401, 1402, and 1403 for applying a visual effect to one touch-on object queue may be at least a part of a circular sector shape. In response to a first contact of a touch gesture on the object 1211, the controller 120 of FIG. 1 may activate a preset touch line 1405 and at least one touch guide region 1401, 1402, and 1403. The memory 130 may store at least one visual effect mapped to the virtual touch guide regions 1401, 1402, and 1403. The controller 120 may identify a virtual touch guide region 1402 to which a third contact of a touch gesture belongs. The controller 120 may operate such that a visual effect corresponding to the identified virtual touch guide region 1402 is applied to a touch-on object 1227 based on mapping information maintained in the memory 130.

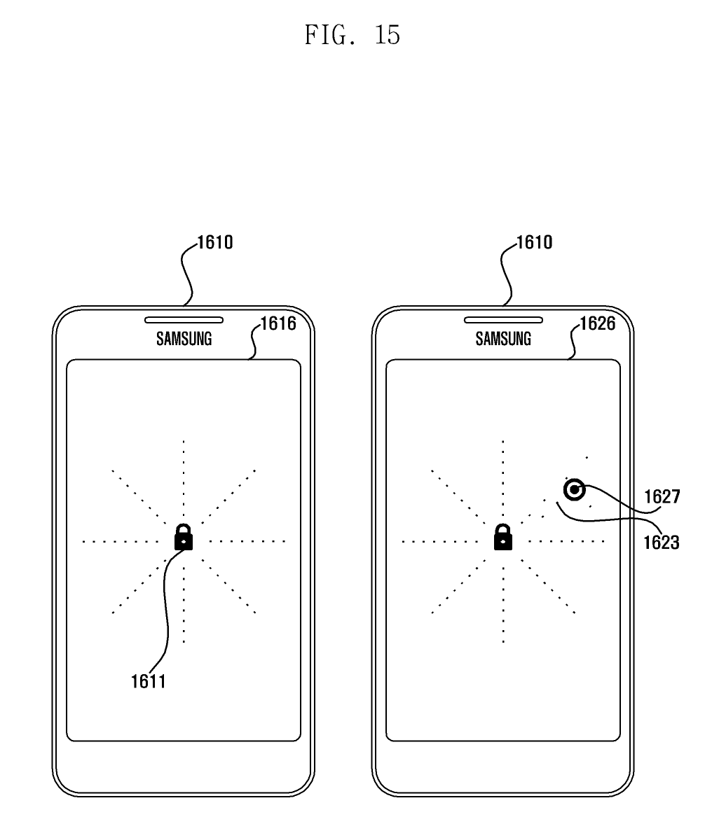

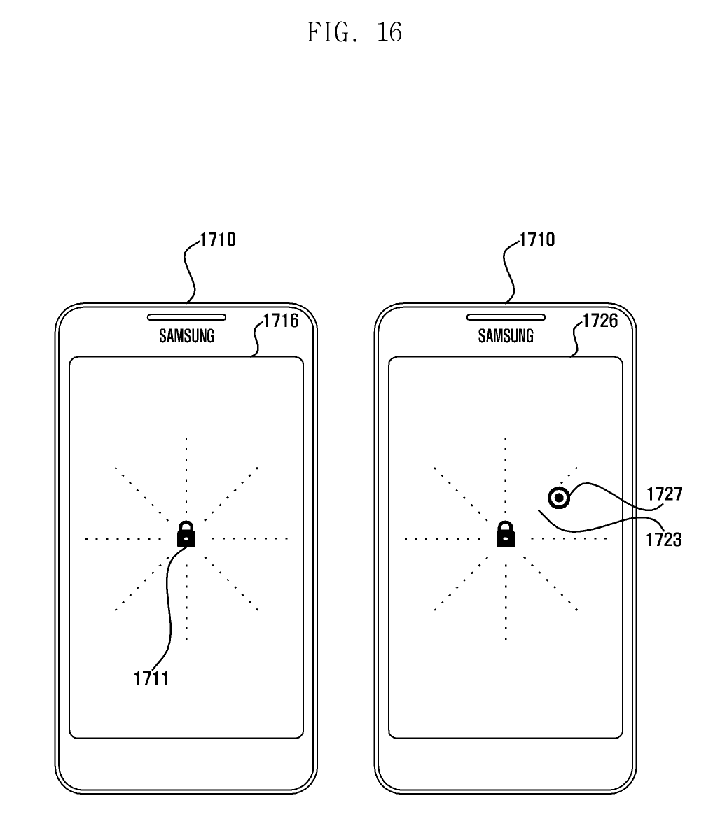

FIG. 15 and FIG. 16 illustrate examples of an effect associated with a direction provided from a terminal 16010, respectively.

In FIG. 15, in response to a first contact of a touch gesture on an object 1611 of a screen 1616 of the terminal 1610, an object-set including a touch-on object of a dotted shape may be displayed on the screen 1616. The controller 120 of FIG. 1 may operate such that a visual effect may be applied to a touch-on object 1623 and displayed on a screen 1626 based on a virtual touch guide region (or virtual direction region and a virtual touch guide line contacting a touch gesture) in which a third contact 1627 of a touch gesture is included. For example, the visual effect may be a changed location of a touch-on object 1623 included in a queue of touch-on objects located relatively near to third contact 1627 of a touch gesture.

In FIG. 16, in response to a first contact of the touch gesture on an object 1711 of a screen 1716 of a terminal 1710, an object-set including a touch-on object of a dotted shape may be displayed on the screen 1716. For example, a controller 120 of FIG. 1 may operate such that a visual effect is applied to the touch-on object 1723 to disappear from the screen 1726 based on a virtual touch guide region (or virtual direction region or virtual touch guide line contacting a touch gesture) in which a third contact 1727 of the touch gesture is included.

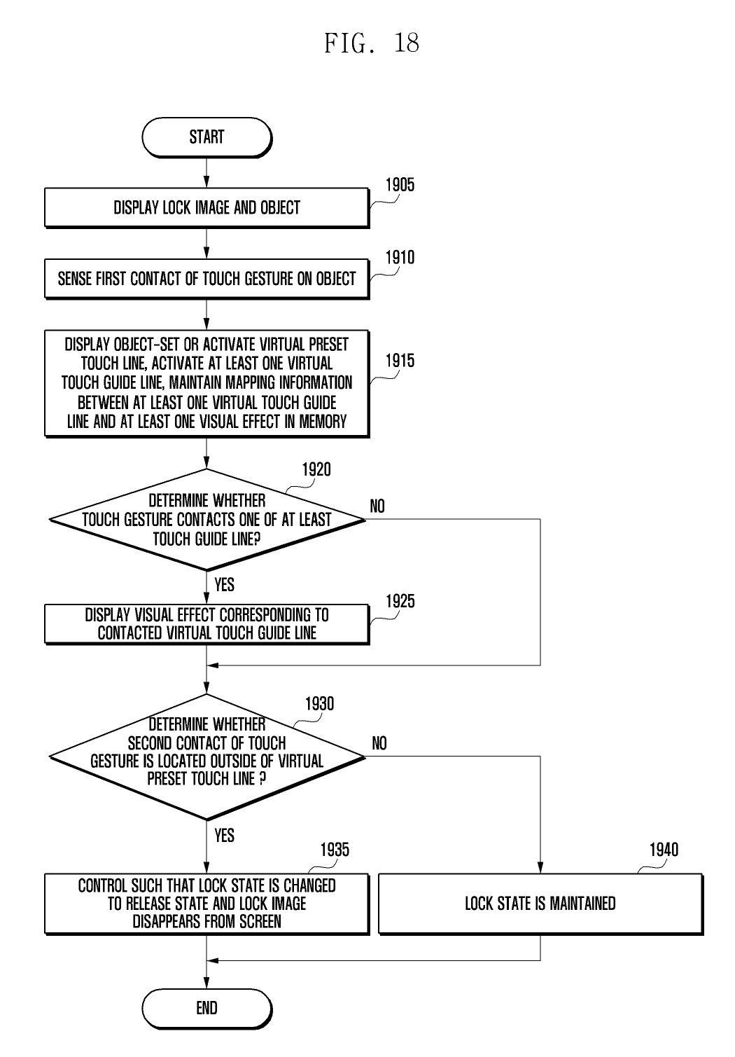

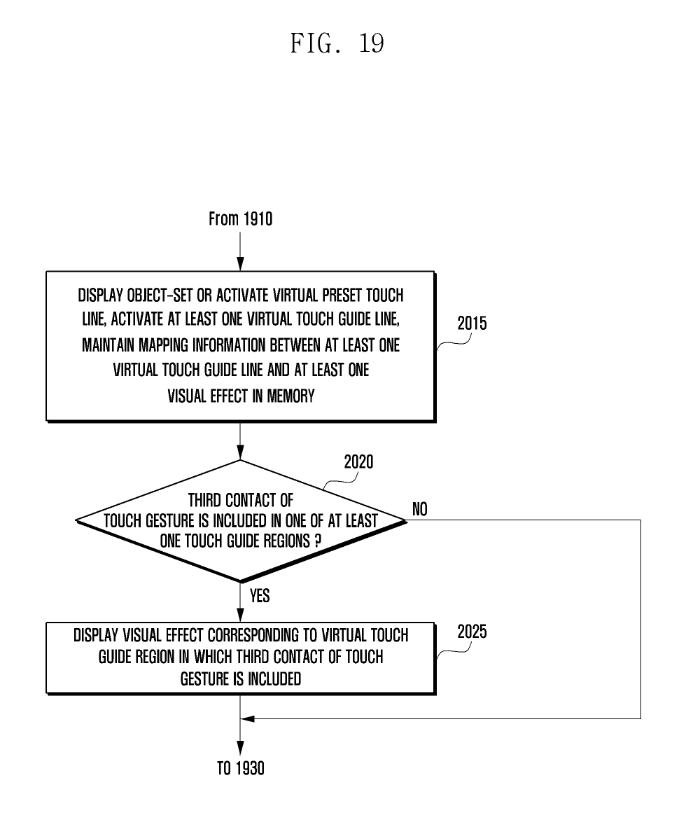

Hereinafter, a method of providing a user interface according to an embodiment of the present invention will be described with reference to FIG. 18 to FIG. 19.

For example, the apparatus 100 for providing a user interface may display a lock image in a lock state with respect to at least a partial UI and an object for changing a lock state to a release state (1905).

The apparatus 100 for providing a user interface may sense a first contact of a touch gesture on an object (1910).

In response to the first contact on the object, the apparatus 100 for providing the user interface may display an object-set or activate a virtual preset touch line (1915). Here, the virtual preset touch line may have a looped curve shape surrounding the object. Further, the apparatus 100 for providing the user interface may activate at least one virtual touch guide line. Here, the at least one virtual touch guide line may have a preset location. Further, the apparatus 100 for providing the user interface may maintain mapping information between at least one virtual touch guide line and at least one visual effect in the memory 130.

The apparatus 100 for providing the UI may determine whether a touch gesture contacts one of the at least touch guide lines (1920). When the touch gesture does not contact one of the at least touch guide line, the apparatus 100 for providing UI may go to step 1930.

When the touch gesture contacts one of the at least touch guide lines, the apparatus 100 for providing UI may display a visual effect corresponding to the contacted virtual touch guide line based on mapping information (1925).

The apparatus 100 for providing UI may determine whether a second contact of a touch gesture is located in an area outside of a virtual preset touch line (1930). When the second contact of the touch gesture is not located outside of the virtual preset touch line (namely, located in an area internal to the virtual preset touch line), the apparatus 100 for providing UI may operate such that the lock state is maintained (1940).

When the second contact of the touch gesture is located outside of the virtual preset touch line, the apparatus 100 for providing UI may operate such that the lock state is changed to a release state, and a lock image is removed from a screen (1935).

Further, the apparatus 100 for providing UI may perform operations of step 2015 to step 2025 instead of operations of step 1915 to step 1925.

For example, after step 1910 of FIG. 18, in response to a first contact of an object, the apparatus 100 for providing the user interface may display an object-set or a virtual preset touch line or activate a virtual preset touch line (2015). The apparatus 100 for providing the UI may further activate at least one virtual touch guide region. Here, the at least one virtual touch guide region may be regions presented on a screen. Moreover, the apparatus 100 for providing the UI may maintain mapping information between at least one virtual touch guide region and at least one visual effect in the memory 130. The apparatus 100 for providing the UI may determine whether a third contact of a touch gesture is included in one of the at least one touch guide regions (2020). When the third contact of the touch gesture is not included in the one of the virtual touch guide regions, the apparatus 100 for providing UI may perform step 1930 of FIG. 18.

When the third contact of the touch gesture is included in the one of the virtual touch guide regions, the apparatus 100 for providing the UI may display a visual effect corresponding to a virtual touch guide region in which the third contact of the touch gesture is included based on the mapping information (2025).

Step 1920 to step 1925 of FIG. 18 or step 2020 to step 2025 of FIG. 19 may be performed simultaneously with step 1930 by the apparatus 100 for providing UI.

Moreover, instead of the foregoing controller 120, a microprocessor or a microcomputer may be used, and an operation thereof may be performed by the embodiment illustrated in FIG. 18 to FIG. 19. Persons of ordinary skill in the art will appreciate that a program with respect to an embodiment illustrated in FIG. 18 to FIG. 19 may be configured by software, hardware, or a combination thereof. Further, the program with respect to an embodiment illustrated in FIG. 18 to FIG. 19 may be downloaded by an apparatus for providing UI from a server or a computer through a communication network.

Since a lock state is controlled without restriction with respect to a path or direction of a movement trace of a touch gesture based on a location or distance of a contact of the touch gesture, the present invention provides convenience of use in changing from a locked state to a release state. In addition, since feedback of the user operation is provided in controlling a lock state, the present invention has an effect that improves intuition use of the interface.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of providing a user interface, the method comprising:
displaying on a screen a lock image with respect to at least a partial user interface and an object for changing a lock state to a release state;
sensing a first contact of a touch gesture on the object;
determining a distance between the object and a second contact of the touch gesture in response to the first contact on the object; and
changing the lock state to the release state and removing the lock image from the screen when the distance between the object and the second contact is greater than a preset threshold.

2. The method of claim 1, further comprising:
displaying an object-set including at least one touch-on object and determining a distance between the object and a third contact of the touch gesture in response to the first contact on the object; and
when the distance between the object and a third contact of the touch gesture is commensurate with one of at least one touch-on distances, applying a visual effect corresponding to the commensurate touch-on distance to the object-set to display the applied visual effect on the screen.

3. An apparatus for providing a user interface, the apparatus comprising:
a controller controlling a display on a screen of a lock image with respect to at least a partial user interface and an object for changing a lock state to a release state; and
a touch sensor sensing a first contact of a touch gesture on the object,
wherein the controller determines a distance between the object and a second contact of the touch gesture in response to the first contact on the object, and
changes the lock state to the release state and removes the lock image from the screen when the distance between the object and the second contact is greater than a preset threshold.

4. The apparatus of claim 3, wherein the controller:
displays an object-set including at least one touch-on object;
determines a distance between the object and a third contact of the touch gesture in response to the first contact on the object; and
applies a visual effect corresponding to a commensurate touch-on distance to the object-set such that the applied visual effect is displayed on the screen when the distance between the object and the third contact of the touch gesture accords with one of the at least one touch-on distances.

5. A method of providing a user interface, the method comprising:
displaying on a screen a lock image with respect to at least a partial user interface and an object for changing a lock state to a release state;
sensing a first contact of a touch gesture on the object;
activating a virtual preset touch line having a looped curve shape surrounding the object in response to the first contact on the object; and
changing the lock state to the release state and removing the lock image from the screen when a second contact of the touch gesture is located in an area outside of the virtual preset touch line.

6. The method of claim 5, further comprising:
activating at least one virtual touch guide line with a preset location in response to the first contact;
maintaining mapping information between the at least one virtual touch guide line and at least one visual effect in a memory; and
when the touch gesture contacts one of the at least one virtual touch guide lines, displaying a visual effect corresponding to the contacted virtual touch guide line.

7. The method of claim 6, wherein the visual effect corresponding to the contacted virtual touch guide line is one of cases where an object-set, including at least one touch-on object arranged one or on and around the contacted virtual touch guide lineappears and disappears.

8. The method of claim 6, wherein the visual effect corresponding to the contacted virtual touch guide line is at least one of a transparency, a color, a luminance, a brightness, a size, a shape, a rotating angle, and a location of an object-set.

9. The method of claim 5, further comprising:
displaying an object-set with at least one touch-on object;
activating at least one virtual touch guide line with a preset location in response to the first contact; and
when the touch gesture contacts one of the at least one virtual touch guide lines, applying a visual effect corresponding to the virtual contacted touch guide line to the object-set to display the applied visual effect on the screen.

10. The method of claim 5, wherein activating a virtual preset touch line comprises:
detecting a distance between the object and the second contact of the touch gesture when the virtual preset touch line is a circle having a center on the object; and
determining whether the distance between the object and the second contact of the touch gesture is greater than a radius of the virtual preset touch line.

11. The method of claim 5, further comprising:
maintaining the lock state when the second contact of the touch gesture is located in an area inside of the virtual preset touch line.

12. The method of claim 5, further comprising:
executing an application corresponding to the object when the second contact of the touch gesture is located in an area outside of the virtual preset touch line.

13. The method of claim 5, further comprising:
activating at least one virtual touch guide region on the screen in response to the first contact on the object;
maintaining mapping information between the at least one virtual touch guide region and at least one visual effect in a memory; and
displaying a visual effect corresponding to a virtual touch guide region in which a third contact of the touch gesture is included based on the mapping information when the third contact belongs to one of the at least one virtual touch guide regions.

14. The method of claim 13, wherein the visual effect corresponding to the virtual touch guide region in which the third contact is included is one of cases where an object-set, including at least one touch-on object arranged one or on and around the contacted virtual touch guide region in which the third contact is included, appears and disappears.

15. The method of claim 13, wherein the visual effect corresponding to the virtual touch guide region in which the third contact is included is at least one of a transparency, a color, luminance, a brightness, a size, a shape, a rotating angle, and a location of an object-set.

16. The method of claim 5, further comprising:
displaying an object-set with at least one touch-on object;
activating at least one virtual touch guide line with a preset location in response to the first contact; and
when a third contact of the touch gesture is included in one of the at least one virtual touch guide regions, applying a visual effect corresponding to the virtual touch guide region in which the third contact is included with the object-set to display the applied visual effect on the screen.

17. An apparatus for providing a user interface, the apparatus comprising:
a controller controlling a display of a lock image in a lock state with respect to at least a partial user interface and an object for changing the lock state to a release state; and
a sensor sensing a first contact of a touch gesture on the object,
wherein the controller:
activates a virtual preset touch line having a looped curve shape surrounding the object in response to the first contact on the object; and
changes the lock state to the release state and removes the lock image from the display when a second contact of the touch gesture is located in an area outside of the virtual preset touch line.

18. The apparatus of claim 17, wherein the controller displays an object-set including at least one touch-on object and activates at least one virtual touch guide line with a preset location in response to the first contact; and
applies a visual effect corresponding to the virtual touch guide line to display the applied visual effect when the touch gesture contacts one of the at least one virtual touch guide lines.

19. The apparatus of claim 17, wherein the controller maintains the lock state when the second contact of the touch gesture is located in an area inside of the virtual preset touch line.

20. The apparatus of claim 17, wherein the controller displays an object-set with at least one touch-on object and activates at least one virtual touch guide line with a preset location in response to the first contact, and
applies a visual effect corresponding to the virtual touch guide region in which a third contact is included to the object-set to display the applied visual effect on the screen when the third contact of the touch gesture is included in one of the at least one virtual touch guide regions.
